(19) United States
(12) Patent Application Publication
(10) Pub. No.: US 2012/0044235 A1
(43) Pub. Date: Feb. 23, 2012

(54) ACTIVE MATRIX ORGANIC LIGHT EMITTING DIODE DISPLAY

(75) Inventors: Sang Hyun CHA, Seoul (KR); Youn Joong LEE, Seoul (KR); Gyu Hyeong CHO, Daejeon (KR); Jin Yong JEON, Daegu (KR); Jun Hyeok YANG, Daegu (KR); Hyun Sik KIM, Jeollabuk-do (KR); Jae Shin LEE, Anyang (KR)

(73) Assignees: KOREA ADVANCED INSTITUTE OF SCIENCE AND TECHNOLOGY, Daejeon (KR); SAMSUNG ELECTRO-MECHANICS CO., LTD., Suwon (KR)

(21) Appl. No.: 13/079,386

(22) Filed: Apr. 4, 2011

(30) Foreign Application Priority Data
Aug. 19, 2010 (KR) 10-2010-0080518

(51) Int. Cl. G09G 3/32; G09G 5/00

(52) U.S. Cl. 345/212; 345/76

(57) ABSTRACT

There is provided an active matrix organic light emitting diode display, including a data driver converting pre-prepared correction data into an analog correction signal and generating a driving signal according to the analog correction signal, a selector selecting a charging path for programming, according to the driving signal in a preset programming period and selecting a deterioration detection path in a preset emission period, a pixel unit including an organic light-emitting diode connected between a power supply receiving power and a ground, charging a value corresponding to the correction data according to the driving signal in the programming period, and allowing current to flow to the organic light-emitting diode according to the charged value in the emission period, and an ADC detecting deterioration voltage having deterioration information of the organic light-emitting diode of the pixel unit in the emission period.

### CROSS-REFERENCE TO RELATED APPLICATIONS

This application claims the priority of Korean Patent Application No. 10-2010-0080518 filed on Aug. 10, 2010, in the Korean Intellectual Property Office, the disclosure of which is incorporated herein by reference.

### BACKGROUND OF THE INVENTION

1. Field of the Invention

The present invention relates to an active matrix organic light, emitting diode display and a driving method thereof, and more particularly, to an active matrix organic light emitting diode display capable of sensing deterioration during an emission period to more rapidly sense deterioration and thus rapidly compensate therefor.

2. Description of the Related Art

Generally, in order to manufacture a large-sized display panel using an organic light-emitting diode (OLED), prominent as a next generation display device, the organic light-emitting diode is configured to have an active matrix structure, known as an active matrix OLED (referred to as an AMOLED).

Since the AMOLED does not require an additional light source, it has improved performance in terms of brightness, thickness, definition, speed, power consumption, and the like, as compared to an LCD panel using a backlight unit (BLU) providing an additional light source.

However, the AMOLED has disadvantages in that uniformity between pixels and uniformity over time are very low, and a circuit for compensating for the uniformity is required.

As an AMOLED driving scheme, there are provided a current driving scheme and a voltage driving scheme. The voltage driving scheme has a disadvantage, in that an output changes due to the deterioration of the mobility or the threshold voltage of a transistor.

In order to solve the disadvantage due to the deterioration of the threshold voltage, a compensation circuit for compensating the deterioration thereof is required. In addition, the AMOLED voltage driving scheme additionally requires a period for sensing a degree of deterioration, thereby causing the time required to detect and compensate for deterioration to be extended.

### SUMMARY OF THE INVENTION

An aspect of the present invention provides an active matrix organic light emitting diode display capable of sensing deterioration during an emission period to more rapidly sense deterioration and thus rapidly compensate therefor.

According to an aspect of the present invention, there is provided an active matrix organic light emitting diode display, including: a data driver converting previously-prepared correction data into an analog correction signal and generating a driving signal according to the analog correction signal; a selector selecting a charging path for programming, according to the driving signal in a preset programming period and selecting a deterioration detection path in a preset emission period; a pixel unit including an organic light-emitting diode connected between a power supply receiving power and a ground, charged with a value corresponding to the correction data according to the driving signal an the programming period, and allowing current to flow to the organic light-emitting diode accord in to the charged value in the emission period; and an analog-to-digital converter (ADC) detecting a deterioration voltage having deterioration information regarding the organic light-emitting diode of the pixel unit in the emission period.

The pixel unit may further include: first and second MOS transistors connected in series between the power supply receiving the power and the organic light-emitting diode; a third MOS transistor connected between a gate of the first MOS transistor and the selector; and a charging capacitor connected between the gate of the first MOS transistor and the power supply.

The pixel unit may be configured such that the first and third MOS transistors are turned on and the second MOS transistor is turned off in the programming period and the first and second MOS transistors are turned on and the third transistor is turned off in the emission period.

The pixel unit may be configured such that current flows from the power supply to the selector through the first and third MOS transistors according to the driving signal, to store the value corresponding to the correction data in the charging capacitor in the programming period, and the current flows from the power supply to the ground through the first and second MS transistors and the organic light-emitting diode, according to the value stored in the charging capacitor in the emission period.

The ADO may be configured to detect the deterioration voltage having the deterioration information regarding the organic light-emitting diode at a connection node between the first and second MOS transistors of the pixel unit in the emission period.

The active matrix organic light emitting diode display may further include: a compensator generating as deterioration compensation signal for compensating for deterioration using the digital deterioration voltage from the ADC; and a converter converting input data into the correction data in which deterioration is compensated for using the deterioration compensation signal to provide the correction data to the data driver.

The active matrix organic light emitting diode display may further include a panel load corresponding to a load of a panel and formed between the selector and the pixel unit.

According to another aspect of the present invention, there is provided an active matrix organic light emitting diode display, including: a data driver converting previously-prepared correction data into an analog correction signal and generating a driving signal according to the analog correction signal, a selector selecting a charging path for programming, according to the driving signal in a preset programming period and selecting a deterioration detection path in a preset emission period; a pixel unit including an organic light-emitting diode connected between a power supply receiving power and a ground, charged with a value corresponding to the correction data according to the driving signal in the programming period, and allowing current to flow to the organic light-emitting diode according to the charged value in the emission period; an analog-to-digital converter (ADC) detecting a deterioration voltage having deterioration information regarding the organic light-emitting diode of the pixel unit in the emission period; a compensator generating a deterioration compensation signal for compensating for deterioration using the digital deterioration voltage from the ADC; and a converter converting input data into the correction data in which deterioration is compensated for using the deterioration compensation signal to provide the correction data to the data driver.

The pixel unit may further include: first and second MOS transistors connected in series between the power supply receiving the power and the organic light-emitting diode; a third MOS transistor connected between a gate of the first MOS transistor and the selector; and a charging capacitor connected between the gate of the first MOS transistor and the power supply.

The pixel unit may be configured such that the first and third MOS transistors are turned on and the second MOS transistor is turned off in the programming period, and the first and second MOS transistors are turned on and the third transistor is turned off in the emission period.

The pixel unit may be configured such that current flows from the power supply to the selector through the first and third MOS transistors according to the driving signal, to store the value corresponding to the correction data in the charging capacitor in the programming period, and the current flows from the power supply to the ground through the first and second MOS transistors and the organic light-emitting diode, according to the value stored in the charging capacitor in the emission period.

The ADC may configured to detect the deterioration voltage having the deterioration information regarding the organic light-emitting diode at a connection node between the first and second MOS transistors of the pixel unit in the emission period.

The active matrix organic light emitting diode display may further include a panel load corresponding to a load of a panel and formed between the selector and the pixel unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of an active matrix organic light emitting diode display according to an exemplary embodiment of the present invention;

FIG. 2 is a flowchart showing an operation of an active matrix organic light emitting diode display according to an exemplary embodiment of the present invention;

FIG. 3 is a time chart of an active matrix organic light emitting diode display according to an exemplary embodiment of the present invention;

FIG. 4 is a diagram describing an operation during a programming period of an active matrix organic light emitting diode display according to an exemplary embodiment of the present invention; and

FIG. 5 is a diagram describing an operation during an emission period of an active matrix organic light emitting diode display according to an exemplary embodiment of the present invention.

### DETAILED DESCRIPTION OF THE PREFERRED EMBODIMENT

Exemplary embodiments of the present invention will now be described in detail with reference to the accompanying drawings.

The present invention should not be limited to the embodiments set forth herein and the embodiments may be used to assist in understanding the technical idea of the present invention. Like reference numerals designate like components having substantially the same constitution and function in the drawings of the present invention.

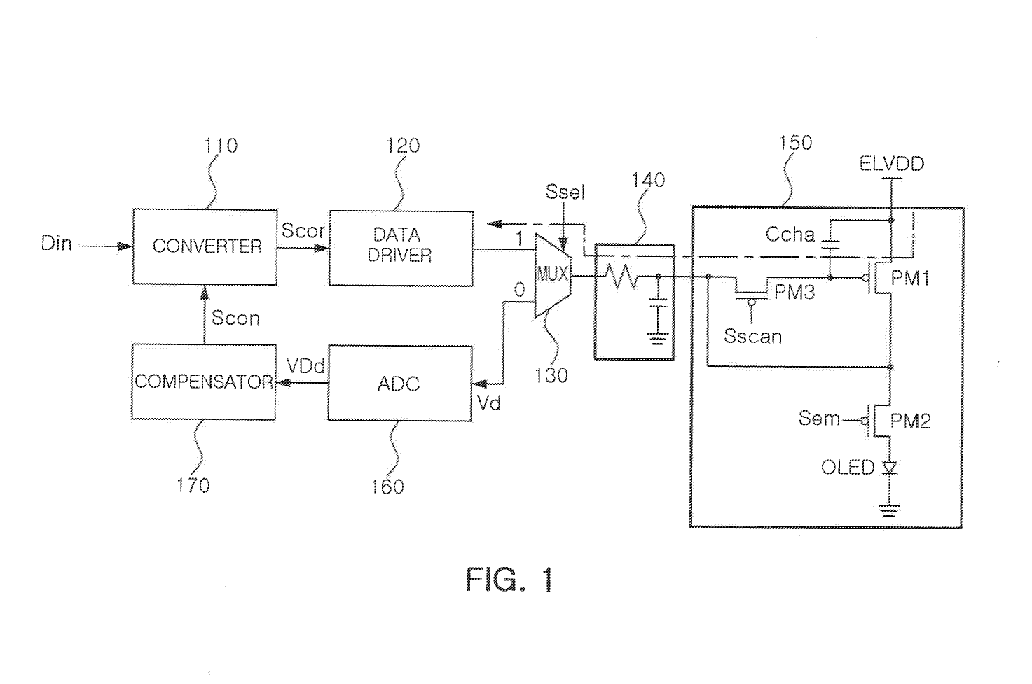

FIG. 1 is a block diagram of an active matrix organic light emitting diode display according to an exemplary embodiment of the present invention.

Referring to FIG. 1, an active matrix organic light emitting diode display according to an exemplary embodiment of the present invention may include a data driver 120 converting previously prepared correction data into an analog correction signal Scor and generating a driving signal according to the analog correction signal Scor, and a selector 130 selecting a charging path for programming, according to the driving signal in a preset programming period (P1) and selecting deterioration detection path in a preset emission period (P2).

Herein, the selector 130 selects the charging path or the deterioration detection path according to a selection signal Ssel. For example, when the selection signal Ssel is high (1), the selector 130 may select the charging path, and when the selection signal Ssel is low (0), it may select the deterioration detection path.

In addition, the active matrix organic light emitting diode display according to an exemplary embodiment of the present invention may include a pixel unit 150 having an organic light-emitting diode OLED connected between a power supply receiving power ELVDD and a ground, charged with a value corresponding to the correction data according to the driving signal in the programming period P1, and allowing current to flow to the organic light-emitting diode OLED according to the charged value in the emission, period P2.

The active matrix organic light emitting diode display according to an exemplary embodiment of the present invention may include an analog-to-digital converter (ADC) 160 detecting a deterioration voltage Vd having deterioration information regarding the organic light-emitting diode OLED of the pixel unit 150 in the emission period P2.

The pixel unit 150 further includes first and second MOS transistors PM1 and PM2 connected in series between the power supply receiving the power ELVDD and the organic light-emitting diode OLED, a third MOS transistor PM3 connected between a gate of the first MOS transistor PM1 and the selector 130, and a charging capacitor Ccha connected between the gate of the first MOS transistor PM1 and the power supply.

The pixel unit 150 may be configured such that the first and third MOS transistors PM1 and PM3 are tuned on and the second MOS transistor PM2 is turned off in the programming period P1, and the first and second MOS transistors PM1 and PM2 are turned on and the third transistor PM3 is turned off in the emission period P2.

In addition, the pixel unit 150 may be configured such that current flows from he power supply to the selector 130 through the first and third MOS transistors PM1 and PM3 according to the driving signal, to store the value corresponding to the correction data in the charging capacitor Ccha in the programming period P1.

Further, the pixel unit 150 may be configured such that the current flows from the power supply to the ground through the first and second MOS transistors PM1 and PM2 and the organic light-emitting diode OLED according to the value stored in the charging capacitor Ccha in the emission period P2.

The ADC 160 may be configured to detect the deterioration voltage Vd having the deterioration information regarding the organic light-emitting diode OLED at a connection node between the first and second MOS transistors PM1 and PM2 of the pixel unit 150 in the emission period P2.

in addition, the active matrix organic light emitting diode display according to an exemplary embodiment of the present invention may further include a compensator 170 generating a deterioration compensation signal Scon for compensating for deterioration using the digital deterioration voltage VDd from the ADC 160, and a converter 110 converting input data into correction data in which deterioration is compensated for using the deterioration compensation signal Scon to provide the correction data to the data driver 120.

Further, the active organic light-emitting diode according to an exemplary embodiment of the present invention may further include a panel load 140 corresponding to a load of a panel and formed between the selector 130 and the pixel unit 150.

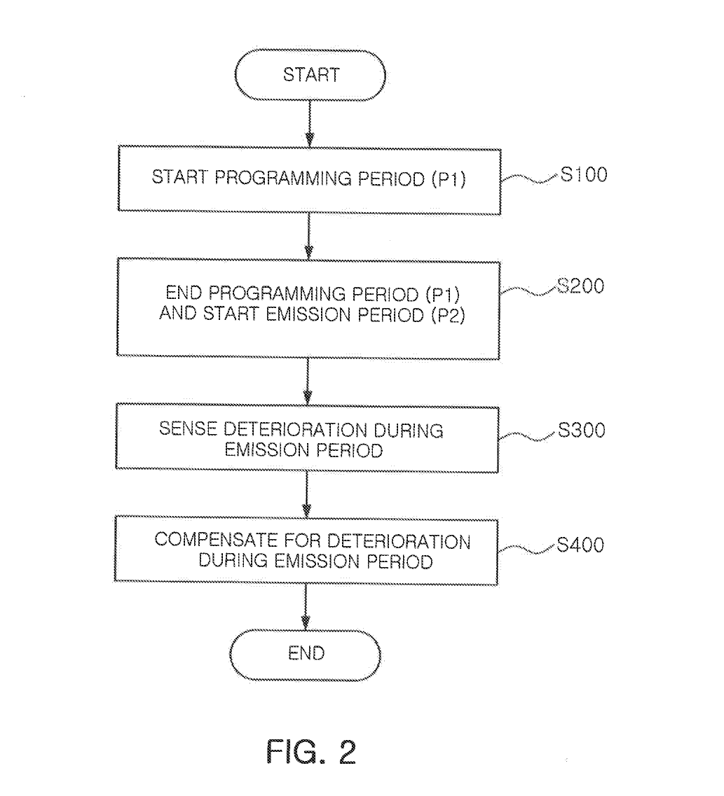

FIG. 2 is a flowchart showing an operation of an active matrix organic light emitting diode display according to an exemplary embodiment of the present invention. A programming period P1 starts (S100) the operation. The programming period P1 ends and an emission period P2 starts (S200). Deterioration is sensed in the emission period (S300) Further, deterioration is compensated for, based on the deterioration sensing in the emission period (P2).

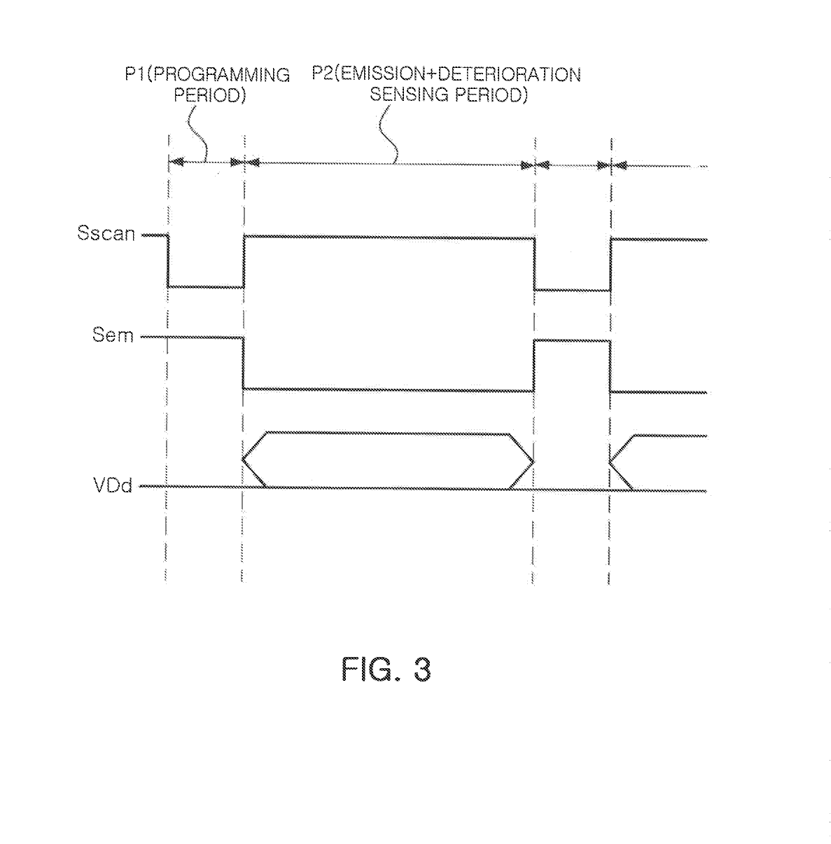

FIG. 3 is a time chart of an active matrix organic light emitting diode display according to an exemplary embodiment of the present invention. In FIG. 3, P1 indicates a programming period, P2 indicates an emission period, Sscan indicates a gate signal applied to a gate of the third MOS transistor PM3 of the pixel unit 150, Sem indicates a gate signal applied to a gate of the second MOS transistor P2 of the pixel unit 150, and VDd indicates digital deterioration voltage outputted from the ADC 160.

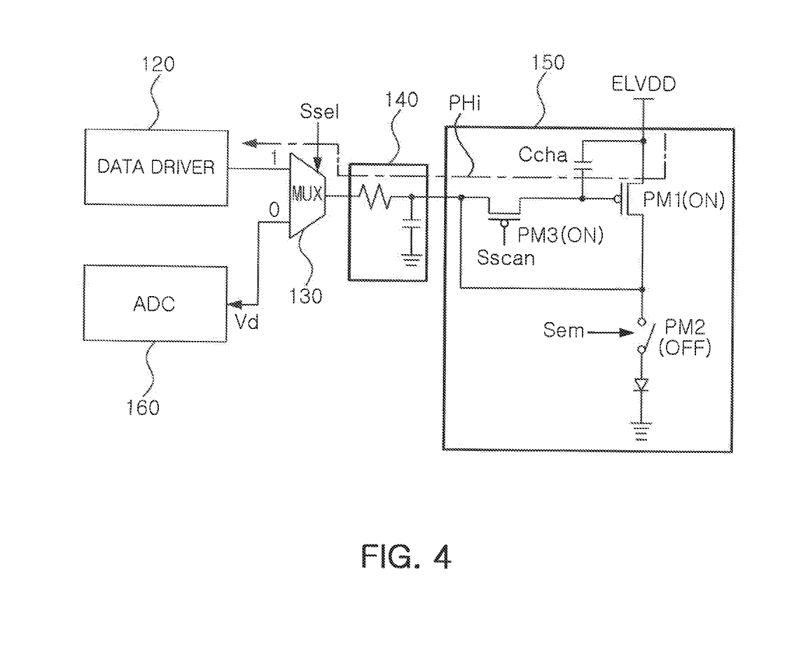

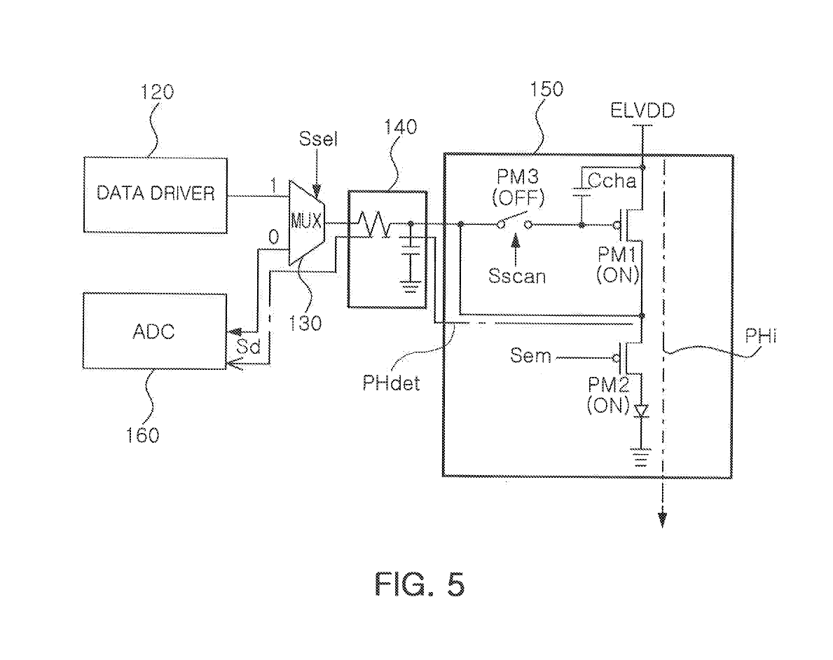

FIG. 4 is a diagram describing an operation during a programming period of an active matrix organic light emitting diode display according to an exemplary embodiment of the present invention, and FIG. 5 is a diagram describing operation during an emission period of an active matrix organic light emitting diode display according to an exemplary embodiment of the present invention.

In FIG. 4, PHi indicates a current path in the programming period P1 in the active matrix organic light emitting diode display according to an exemplary embodiment of the present invention. In FIG. 5, PHdet indicates a deterioration detection path in the active matrix organic light emitting diode display according to an exemplary embodiment of the present invention.

Hereinafter, the operations and effects of the present invention will be described with reference to the accompanying drawings.

The active matrix organic light emitting diode display according to an exemplary embodiment of the present invention will be described for each of preset programming period P1 and emission period P2 with reference to FIGS. 1 to 5.

First, operation during the programming period P1 of the active matrix organic light emitting diode display according to an exemplary embodiment of the present invention will be described.

Referring to FIG. 1, the data driver 120 according to an exemplary embodiment of the present invention starts an operation, corresponding to the programming period, to convert the pre-prepared correction data into the analog correction signal Scor and generate the driving signal according to the analog correction signal Scar (S100), as shown in FIG. 2.

The selector 130 according to an exemplary embodiment of the present invention selects the charging path for programming, according to the driving signal in the preset programming period P1.

That is, the selector 130 selects the charging path according to the selection signal (Ssel). For example, when the selection signal Ssel is high (1), the selector 130 may select the charging path.

At this time, the pixel unit 150 may be charged with the value corresponding to the correction data according to the driving signal in the programming period P1.

That is, the pixel unit 150 turns on the first and third MOS transistors PM1 and PM3 and turns off the second MOS transistor PM2 in the programming period P1.

Accordingly, since the current path is selected in the selector 130 according to an exemplary embodiment of the present invention, the pixel unit 150 may allow the current to flow from the power supply to the selector 130 through the first and third MOS transistors PM1 and PM3 according to the driving signal, to store the value corresponding to the correction data in the charging capacitor Ccha in the programming period P1, as shown in FIG. 4.

Then, as shown in FIGS. 2 and 3, the programming period P1 of the active matrix organic light emitting diode display according to an exemplary embodiment of the present invention ends and the emission period P2 thereof starts.

Meanwhile, the converter 110 according to an exemplary embodiment of the present invention may convert the input data Din into the correction data in which deterioration is compensated for to provide the correction data to the data driver 120.

Hereinafter, operation during the emission period P2 of the active matrix organic light emitting diode display according to an exemplary embodiment of the present invention will he described.

Referring to FIG. 1, the selector 130 according to an exemplary embodiment of the present invention starts an operation, corresponding to the emission period P2, to select the deterioration detection path in the preset emission period P2.

That is, the selector 130 may select, the deterioration detection path according to the selection signal Ssel. For example, when the selection signal Ssel is low (0) the selector 130 may select the deterioration detection path.

In addition, the pixel unit 150 according to an exemplary embodiment of the present invention allows the current to flow to the organic light-emitting diode OLED according to the charged value in the emission period P2.

That is, the pixel unit 150 turns on the first and second MOS transistors PM1, and PM2 and turns off the third MOS transistor PM3 in the emission period P2.

Accordingly, the pixel unit 150 allows the current to flow from the power supply to the ground through the first and second MOS transistors PM1 and PM2 and the organic light-emitting diode OLED according to the value stored in the charging capacitor Ccha in the emission period P2.

At the same time, the ADC 160 according to an exemplary embodiment of the present invention may detect the deterioration voltage Vd having the deterioration information regarding the organic light-emitting diode OLED of the pixel unit 150 through the deterioration detection path, selected in the selector 120, in the emission period P2.

That is, the ADC 160 may detect the deterioration voltage Vd having the deterioration information regarding the organic light-emitting diode OLED at the connection node between the first and second MOS transistors PM1 and PM2 of the pixel unit 150 in the emission period P2.

The compensator 170 according to an exemplary embodiment of the present invention may continuously generate the deterioration compensation signal Scon for compensating for deterioration using digital deterioration voltage VDd from the ADC 160 to provide the deterioration compensation signal to the converter 110.

At this time, the converter 110 converts the input data Din into the correction data in which the deterioration is compensated for using the deterioration compensation signal Scon to provide the correction data to the data driver 120.

Accordingly, as described above, the data driver 120 may convert the correction data into the analog correction signal Scor and generate the driving signal according to the analog correction signal Scor.

As set forth above, according to the exemplary embodiments of the present invention, deterioration due to aging, temperature, and a process may be compensated for without being influenced by the deterioration of the mobility, the threshold voltage, and the like, of a transistor, with respect to the output thereof.

In addition, the influence due to the deterioration of the mobility and the threshold voltage of the transistor, with respect to the current driving the OLED, may be removed using a compensation current driving scheme. Furthermore, the deterioration degree of the OLED is sensed in the emission period without separately requiring a period sensing the deterioration degree of the OLED, such that deterioration may be compensated for, while the screen is displayed.

As set forth above, according to the exemplary embodiments of the present invention, the sensing and compensation of deterioration are simultaneously performed in the emission period, such that deterioration may be more rapidly sensed and compensated for.

while the present invention has been shown and described in connection with the exemplary embodiments, it will be apparent to those skilled in the art that modifications and variations can be made without departing from the spirit and scope of the invention as defined by the appended claims.

What is claimed is:

1. An active matrix organic light emitting diode display, comprising:
a data driver converting previously prepared correction data into an analog correction signal and generating a driving signal according to the analog correction signal;
a selector selecting a charging path for programming, according to the driving signal in a preset programming period and selecting a deterioration detection path in a preset emission period;
a pixel unit including an organic light-emitting diode connected between a power supply receiving power and a ground, charged with a value corresponding to the correction data according to the driving signal in the programming period, and allowing current to flow to the organic light-emitting diode according to the charged value in the emission period; and
an analog to digital converter (ADC) detecting a deterioration voltage having deterioration, information regarding the organic light-emitting diode of the pixel unit in the emission period.

2. The active matrix organic light emitting diode display of claim l, wherein the pixel unit further includes:
first and second MOS transistors connected in series between the power supply receiving the power and the organic light-emitting diode;
a third MOS transistor connected between a gate of the first MOS transistor and the selector; and
a charging capacitor connected between the gate of the first MOS transistor and the power supply.

3. The active matrix organic light emitting diode display of claim 2, wherein the pixel unit is configured such that the first and third MOS transistors are turned on and the second MOS transistor is turned off in the programming period and the first and second MOS transistors are turned on and the third transistor is turned off in the emission period.

4. The active matrix organic light emitting diode display of claim 3, wherein the pixel unit is configured such that current flows from the power supply to the selector through the first and third MOS transistors according to the driving signal, to store the value corresponding to the correction data in the charging capacitor in the programming period, and the current flows from the power supply to the ground through the first and second MOS transistors and the organic light-emitting diode, according to the value stored in the charging capacitor in the emission period.

5. The active matrix organic light emitting diode display of claim 4, wherein the ADC is configured to detect the deterioration voltage having the deterioration information regarding the organic light-emitting diode at a connection node between the first and second MOS transistors of the pixel unit in the emission period.

6. The active matrix organic light emitting diode display of claim 5, further comprising:
a compensator generating a deterioration compensation signal for compensating for deterioration using a digital deterioration voltage from the ADC; and
a converter converting input data into the correction data in which deterioration is compensated for using the deterioration compensation signal to provide the correction data to the data driver.

7. The active matrix organic light emitting diode display claim 6, further comprising a panel load corresponding to a load of a panel and formed between the selector and the pixel unit.

8. An active matrix organic light emitting diode display, comprising:
a data driver converting previously-prepared correction data into an analog correction signal and generating a driving signal according to the analog correction signal;
a selector selecting a charging path for programming, according to the driving signal in a preset programming period and selecting a deterioration detection path in a preset emission period;
a pixel unit including an organic light-emitting diode connected between a power supply receiving power and a ground, charged with a value corresponding to the correction data according to the driving signal in the programming period, and allowing current to flow to the organic light-emitting diode according to the charged value in the emission period;
an analog-to-digital converter (ADC) detecting deterioration voltage having deterioration information regarding the organic light-emitting diode of the pixel unit in the emission period;
a compensator generating a deterioration compensation signal for compensating for deterioration, using a digital deterioration voltage from the ADC; and
a converter converting input data into the correction data in which deterioration is compensated for using the deterioration compensation signal to provide the correction data to the data driver.

9. The active matrix organic light emitting diode display of claim 8, wherein the pixel unit further include
first and second MOS transistors connected in series between the power supply receiving the power and the organic light-emitting diode;
a third MOS transistor connected between a gate of the first MOS transistor and the selector; and
a charging capacitor connected between the gate of the first MOS transistor and the power supply.

10. The active matrix organic light emitting diode display of claim 9, wherein the pixel unit is configured such that the first and third MOS transistors are turned on and the second MOS transistor is turned off in the programming period, and the first and second MOS transistors are turned on and the third transistor is turned off in the emission period.

11. The active matrix organic light emitting diode display of claim 10, wherein the pixel unit is configured such that current flows from the power supply to the selector through the first and third MOS transistors according to the driving signal, to store the value corresponding to the correction data in the charging capacitor in the programming period, and the current flows from the power supply to the ground through the first and second MOS transistors and the organic light-emitting diode, according to the value stored in the charging capacitor in the emission period.

12. The active matrix organic light emitting diode display of claim 11, wherein the ADC is configured to detect the deterioration voltage having the deterioration information regarding the organic light-emitting diode at a connection node between the first and second MOS transistors of the pixel unit in the emission period.

13. The active matrix organic light emitting diode display claim 12, further comprising a panel load corresponding to a load of a panel and formed between the selector and the pixel unit.
